(19) United States
(12) Patent Application Publication
(10) Pub. No.: US 2025/0023271 A1
(43) Pub. Date: Jan. 16, 2025

(54) Distributed Multi-Sensor Multi-Mode Quick Disconnect System

(71) Applicant: Orbital Outpost X, Inc., Santa Clara, CA (US)

(72) Inventor: Dan Slater, La Habra Heights, CA (US)

(21) Appl. No.: 18/770,613

(22) Filed: Jul. 11, 2024

Related U.S. Application Data
(60) Provisional application No. 63/526,942, filed on Jul. 14, 2023.

(51) Int. Cl. H01R 13/00; F16L 39/00; G01D 21/02; H01R 13/66

(52) U.S. Cl. CPC H01R 13/005; F16L 39/00; G01D 21/02; H01R 13/6683

(57) ABSTRACT

A universal multi-sensor quick disconnect interface is provided. In one embodiment, the interface is mechanically androgynous (i.e., capable of connecting with a second identical interface) and reconfigurable to be either connectively androgynous or non-androgynous. To be mechanically androgynous, corresponding connectors are provided to the left and right of the center y-axis, where each connector is equidistant from both a center x and y-axis and opposite in gender (i.e., male, female). The connectivity of corresponding connectors left and right of center can either be separate (non-androgynous) or tied together (androgynous), which may be accomplished via a switch, a wye, etc. The interface may further include at least one sensor for measuring at least one metric of a medium (e.g., fluid, gas, etc.) or energy (power, data, optical, etc.) transferred therethrough and at least one processor for controlling at least one feature of said interface in response thereto.

### BACKGROUND OF THE INVENTION

### 1. Field of the Invention

The present invention relates to universal multi-sensor quick disconnect interface, or more particularly to a universal interface that is mechanically androgynous (i.e., capable of connection with a second identical interface) and reconfigurable to be connectively androgynous or non-androgynous. The interface further includes a plurality of sensors for measuring at least one metric of a medium (e.g., fluid, gas) and/or energy transferred therethrough and a processor for controlling said interface in response thereto.

### 2. Description of Related Art

Connectors come in all different shapes and sizes and are configured for different (and in most instances specific) applications. For example, some connectors are utilized to transfer gas, others to transfer fluid, and yet others to transfer electrical signals (e.g., power, data, radio, optical, etc.). However, such a connection generally required two different types of connectors—a male connector and a female connector—configured to mate with each other. For example, with respect to electrical connectors for computers, they generally include a series of pins (male) configured to mate with a series of sockets (female). The same is true for connection interfaces, where more than one connector is located on a substrate or panel. This is because one must be configured to mate with the other. This is generally accomplished by populated a first substrate with male connectors and the other substrate with female connectors.

A disadvantage with this is that it requires two different and distinct connectors, which makes it more difficult for a manufacturer, who has to manufacture different connectors, a distributor, whose has to purchase and stock different connectors, and a consumer (or user) who, for a single faulty connection, must either determine which connector is faulty or purchase both types of connectors. Obviously, the foregoing is compounded when dealing with interfaces having several connectors, which (for industrial applications) can be quite expensive, and difficult to locate and/or repair.

As such, it would be advantageous to design a mechanically androgynous interface, allowing a single interface having a plurality of connectors (e.g., for transmitting gas, fluid, and/or energy) to mate with itself, so that only one interface is needed. If such an interface includes both male and female connectors (to make the interface mechanically androgynous), then it may also be advantageous to configure the connections to be either androgynous or non-androgynous, depending on the application. As such, it would be advantageous for the interface to be configurable (connectively) between the two.

However, such a connector may require rotation about an axis for the connector to be able to mate with itself. As such, care must be taken to ensure that proper connections are being made. Thus, it would also be advantageous to design an interface that includes sensors and at least one processor for receiving and processing sensor data. For example, in the case where a first connector on the interface functions to transfer fluid, and a second connector on the interface functions to transfer gas, at least one sensor may be used to measure at least one metric associated with at least one connector (or a fluid/gas transferred therethrough) (e.g., bubbles in the fluid, indicative of gas being mixed with fluid, etc.). A processor could then be used to receive said metric and to response accordingly (e.g., notify a user or host, etc.).

Further advantages can be achieved if the processor is configured to receive additional information (e.g., sensed metrics from other interfaces, including, but not limited to, a second mating interface). Such information can be processed (e.g., compare first fluid sensor data from a first interface to first fluid sensor data from a second (mating) interface to ensure proper sensor functionality) and, if necessary, take action (e.g., notify a user or a host of a sensor malfunction, disable power, control electrical switches and/or circuit breakers, fluid valves, automated androgynous connector latches, etc.).

In light of the foregoing, it would be advantageous to develop an androgynous, reconfigurable to be non-androgynous multi-sensor, multi-mode quick disconnect interface that is capable of connecting with a second identical interface for the transfer of at least one medium (e.g., gas, fluid, etc.) and/or at least one energy (e.g., power, data, etc.), where the universal interface is configured to sense at least one metric associated with at least one connector or at least one medium or energy transferred therethrough and to take at least one action in response thereto.

### SUMMARY OF THE INVENTION

The present invention provides a universal multi-sensor quick disconnect interface. In preferred embodiments, the interface is mechanically androgynous (i.e., capable of connecting with a second identical interface) and reconfigurable to be either connectively androgynous or non-androgynous. The interface preferably includes at least one sensor for measuring at least one metric of a medium (e.g., fluid, gas, etc.) or energy (power, data, optical, etc.) transferred therethrough and at least one processor for controlling at least one feature of said interface in response thereto.

Advantages of the present invention are achieved through elements that are attached to the interface (e.g., processor, sensors, effectors, etc.), including functionalities associated therewith, and the mechanical androgynous nature of the interface, which allows the interface to be connected to a second identical interface. Another advantage of the present invention is that while the interface is mechanically androgynous, the connectivity may be reconfigurable to be either androgynous or non-androgynous, thereby providing increased flexibility to the user.

With respect to the prior (i.e., mechanically androgynous), corresponding connectors are provided to the left and right of the center y-axis, where each connector is (a) equidistant from the center y-axis, the same distance from a top of the interface (or alternatively, from the center x-axis), and (c) opposite in gender (i.e., male, female). This allows a first interface to mate with an identical second interface when the second interface is rotated 180° with respect to the center y-axis.

In preferred embodiments, the interface includes connectors that are configured to transfer at least one medium (e.g., fluid or gas) and/or connectors for communicating energy (e.g., power signals, data signals, RF, optical). As such, by way of example, the interface may include both male and female compression fittings (e.g., for fluid) and both male and female electrical connectors (e.g., for power and data).

With respect to the latter (connectively reconfigurable between androgynous and non-androgynous), connectors to the left of center may be separate and distinct from those to the right of center. Doing so makes the interface connectively non-androgynous. As such, a user would need to ensure that certain mediums and/or energies are not mixed during rotation of the second interface. However, in certain embodiments, the interface may be configured to be connectively androgynous, which is accomplished by tying together corresponding connectors left and right of the center y-axis. For electrical connections, this can be accomplished via a physical connection or a physical or electrical switch (e.g., controlled via the processor). For gas and fluid connections, this can be accomplished via a wye (or “Y” or “T”) between corresponding male and female connections on the interface.

In certain embodiments, the interface (or an associated PCB) further comprises a plurality of sensors for measuring a plurality of metrics associated with certain connectors or mediums and/or energies passing therethrough. Such metrics include, for example, pressure, temperature, humidity, bubbles, sound, electromagnetic spectrum, and power, just to name a few. Sensors and/or other components may also assist in mating a first interface with a second interface (e.g., via a robotic arm), such as a nine degrees of freedom sensor, an IR camera, LIDAR, etc.

The interface (or an associated PCB) may further include at least one processor for receiving and processing sensor data and performing at least one action in response to the same. For example, the processor may be configured to control at least one feature of the interface (e.g., turn the interface or any connector associated therewith on or off (which may be done electrically or via an associated component, such as a valve for fluid or gas), reduce power, activate LED status lights, etc.) in response to sensor data. The processor may be configured to do so autonomously or in response to commands or other sensor data received from a remotely located host device.

In one embodiment, the actions taken by the processor may also take into account sensor data received from the mating interface. For example, sensor data from the second (mating) interface may be communicated to the first interface (e.g., via at least one wire or wirelessly), thereby providing the processor with additional information on at least one medium and/or energy passing therethrough. This, for example together with information receive from a connected network, would allow the processor to take actions or control at least one feature on the interface in response to not only local sensor data, but data from at least one other interface.

It should be appreciated that while an interface that is mechanically and connectively androgynous may require additional connectors (e.g., to allow it to mate with an identical connector), there are benefits to such a design. For example, when configured connectively non-androgynous, the number of connections are doubled, thereby taking advantage of the additional connectors on the interface. Alternatively, when configured connectively androgynous, a certain level of redundancy is provided, which is beneficial when a connector or sensor fails. There are also benefits of having identical sensors (one on the first interface and one on the second (mating) interface) measure the same metric. For example, different metrics for the same medium or energy may indicate that one of the sensors has failed. If, however, the metrics are identical, a “reality check” is provided, ensuring that the readings are indeed correct.

A more complete understanding of a distributed multi-sensor, multi-mode quick disconnect interface will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 depicts a front side of an interface in accordance with one embodiment of the present invention prior to components being attached thereto;

FIG. 2 depicts a front side of the interface depicted in FIG. 1 after exemplary components have been attached thereto (i.e., assembled);

FIG. 3 illustrates the symmetrical nature of the assembled interface depicted in FIG. 2 with connectors to the left and right of the center y-axis being equidistant from the same and opposite in gender, making the interface mechanically androgynous;

FIG. 4 provides another example of how components to the left and right of the center y-axis can mirror one another, making the interface mechanically androgynous;

FIGS. 5A and B depict two identical interfaces connected together, thereby illustrating the mechanically androgynous nature of an interface in accordance with one embodiment of the present invention;

FIGS. 6 and 7 depict a removable wye (“Y”) in accordance with one embodiment of the present invention, where removing the wye (“Y”) from the interface results in an interface that is connectively non-androgynous;

FIGS. 8A and B depict a nonlinear load limiter in accordance with one embodiment of the present invention;

FIG. 9 depicts a rear side of an interface in accordance with one embodiment of the present invention, wherein the interface includes a processor and at least one sensor;

FIG. 10 depicts a front side of an interface in accordance with another embodiment of the present invention;

FIGS. 11A and B provide front and perspective (exploded) views, respectively, of a front side of an exemplary printed circuit board (PCB) having at least one electrical connector, at least one sensor, and a processor, wherein the PCB is configured to mate to a backside of the interface depicted in FIG. 10;

FIGS. 12A and B provide perspective (exploded) and rear (assembled) views, respectively, of the interface and PCB depicted in FIGS. 10 and 11A; and

FIG. 13 illustrates a networked version of the present invention where information sensed from one interface can be shared with a host and/or other interfaces allowing certain actions to be performed in response thereto.

### DETAILED DESCRIPTION OF THE PREFERRED EMBODIMENT

In general, the present invention comprises a universal multi-sensor quick disconnect interface, or more particularly a universal interface that is mechanically androgynous (i.e., capable of connecting with a second identical interface) and reconfigurable to be either connectively androgynous or non-androgynous. The interface preferably includes at least one sensor for measuring at least one metric of a medium (e.g., fluid, gas, etc.) or energy (power, data, optical, etc.) transferred therethrough and at least one processor for controlling at least one feature of said interface in response thereto.

As discussed in greater detail below, advantages of the present invention are achieved through elements that are attached to the interface (e.g., connectors, processor, sensors, etc.), including functionalities associated therewith, and the mechanical androgynous nature of the interface, which allows the interface to be connected to a second identical interface. Another advantage of the present invention is that while the interface is mechanically androgynous, the connectivity may be reconfigurable to be either androgynous or non-androgynous, thereby providing increased flexibility to the user.

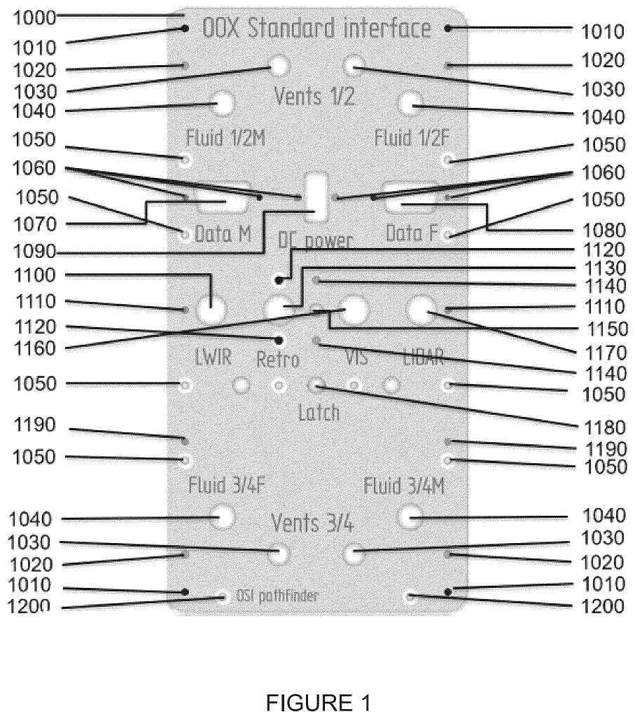

Preferred and alternate embodiments of the present invention will now be described. It should be appreciated that these embodiments are merely exemplary and nonlimiting examples of the present invention. As such, other interfaces, including those with different shapes and/or configurations, are within the spirit and scope of the present invention. For example, an exemplary rectangular interface having certain components (e.g., sensors, connectors, etc.) is depicted in FIGS. 1-3. Those skilled in the will understand that an interface having a different shape (e.g., circular, etc.) and/or fewer, additional, or different components to accommodate different applications is within the spirit and scope of the present invention.

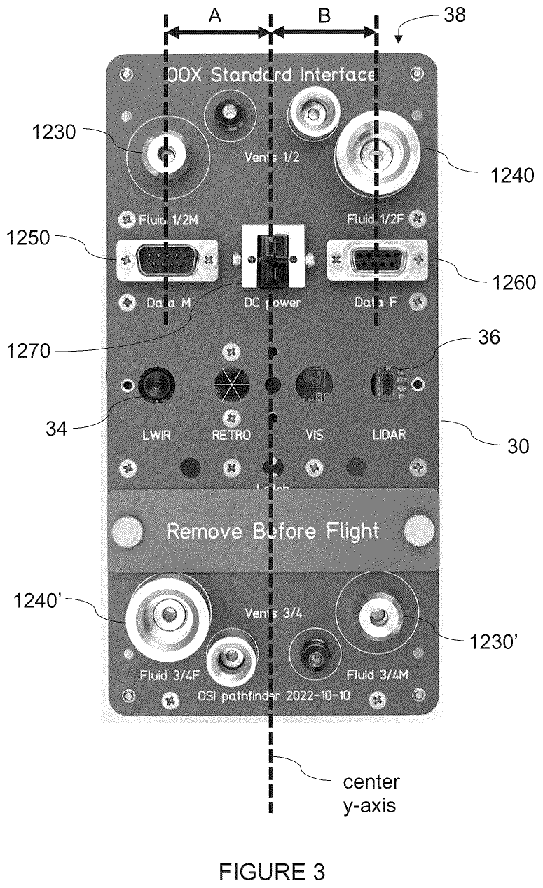

As discussed, a critical feature of the present invention is the mechanically androgynous nature of the interface. As shown in FIG. 3, this can be achieved by providing symmetry along the center y-axis, with corresponding connections to the left and right of the center y-axis being (a) equidistant from the center y-axis and (b) opposite in gender (i.e., male, female). It should be appreciated that other configurations are within the spirit and scope of the present invention. For example, symmetry could also be provided with respect to the center x-axis, etc.

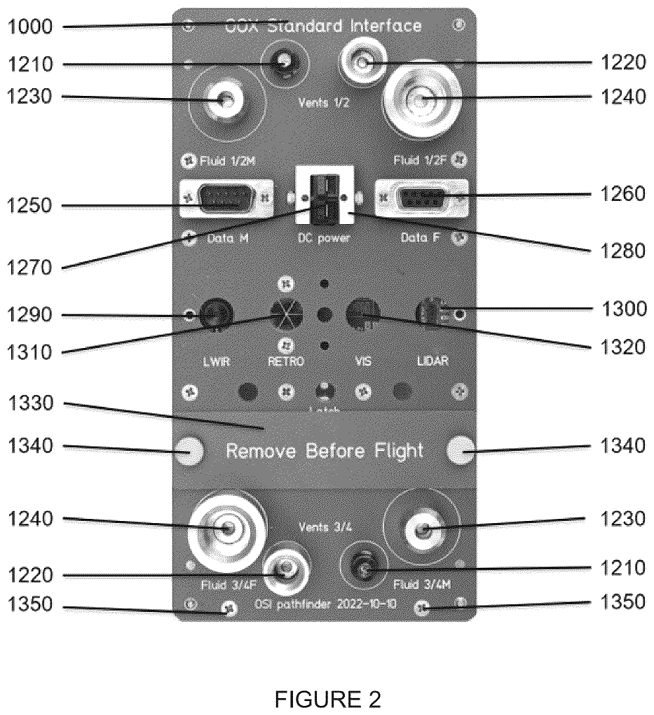

It should also be appreciated that while certain components are depicted in FIG. 3, fewer, additional, and/or different components are within the spirit and scope of the present invention. For example, while the interface of FIG. 3 includes certain components (e.g., fluid connecters, electrical connectors, and cameras, including long-range infrared (IR) and light detection and range (LIDAR)), other components (e.g., sensors, additional cameras, different connectors, etc., are within the spirit and scope of the present invention. With this understanding, a brief discussion of the components will now be made with reference to FIGS. 1 and 2.

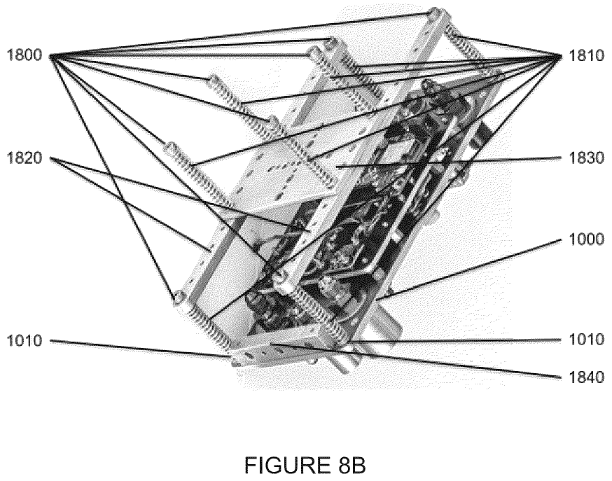

As shown in FIG. 1, the interface 1000 may include a plurality of cutouts and/or apertures for receiving a plurality of components, including, but not limited to, at least one LED (or the like, e.g., short range optical com, light sensing, RAS) (1020, 1050 1140) (e.g., computer controlled multicolor LEDS used for docking illumination, XYZ yaw, pitch, roll alignment, visually showing interface status information, high lumen LED for longer range optical acquisition and for optical communications, etc.), vent fluid mechanical interface (“FMI”) 1030, fluid FMI 1040, male data connector 1070, female data connector 1080, power connector 1090, long-wave infrared (IR) 1100, retroreflector 1120, IR camera 1160, LIDAR 1170, and/or latch pin 1180. The interface may further include a plurality of other cutouts or apertures, e.g., for receiving at least one nonlinear load limiter 1010 (see FIGS. 8A, 8B), attaching a printed circuit board (PCB) to the interface 1050, attaching a protective cover 1110, attaching a retroreflector (1100, 1130, 1160, 1170), viewing the retroreflector 1130, attachments for laboratory testing 1200, and/or receiving (or making visible) any of the foregoing components (e.g., LEDs, cameras, etc.).

Attachment and/or visibility of the foregoing components can be seen in FIG. 2, including, but not limited to, at least one male vent FMI 1210, female vent FMI 1220, male fluid FMI 1230, female fluid FMI 1240, male data connector 1250, female data connector 1260, power coupler 1270, power coupler mounting bracket 1280, long-wave IR camera 1290, LIDAR 1300, retroreflector 1310, visible spectrum camera 1320, protective cover 1330, thumb screws for protective cover 1340, and/or screws for testing mount 1350.

Referring back to FIG. 3, the illustrated interface 30 includes a plurality of connectors equidistant from center y-axis. For example, interface 30 may include a male FMI 1230 a first distance (A) from the center y-axis and a corresponding female FMI 1240 a second distance (B) from the center y-axis, where A=B. By placing 1230 and 1240 the same distance from the center y-axis, and also the same distance from a top of the interface 38 (or alternatively x-axis centerline), the connector (i.e., first connector) become androgynous in that it can mate with an identical second interface when the second interface is rotated 180° with respect to the center y-axis. In other words, after such rotation, the male FMI 1230 on the second interface can mate with the female FMI 1240 on the first interface, and the male FMI 1230 on the first interface can mate with the female FMI 1240 on the second interface.

The same is true with respect to other male and female FMIs (1230′, 1240′, respectively) and other male and female electrical connector (1250, 1260, respectively), again, assuming they are positioned equidistance from the center y-axis and the top (or bottom) of interface 38. It should be appreciated that the present invention is not limited to FIG. 3, and an interface having different, fewer, and/or additional components (including connectors) is within the spirit and scope of the present invention. It should also be appreciated that present invention is not limited to the FMIs (e.g., compressing fittings with a beveled (or tapered) edge (male) and a corresponding interior (tapered) cavity (female)) or electrical connectors (D-miniature connector having pins and sockets) as illustrated, and may include any type of connectors generally known to those skilled in the art for transmitting any medium (e.g., fluid or gas) (compression or otherwise) and/or energy (e.g., power, data, light, etc.) (electrical connectors, fiberoptic connectors, etc.). It should further be appreciated that the androgynous nature of the present invention is not limited to opposing connectors being spaced equidistance from a centerline (e.g., x or y). For example, a hermaphroditic connector located on the centerline (e.g., DC power 1270) is within the spirit and scope of the present invention.

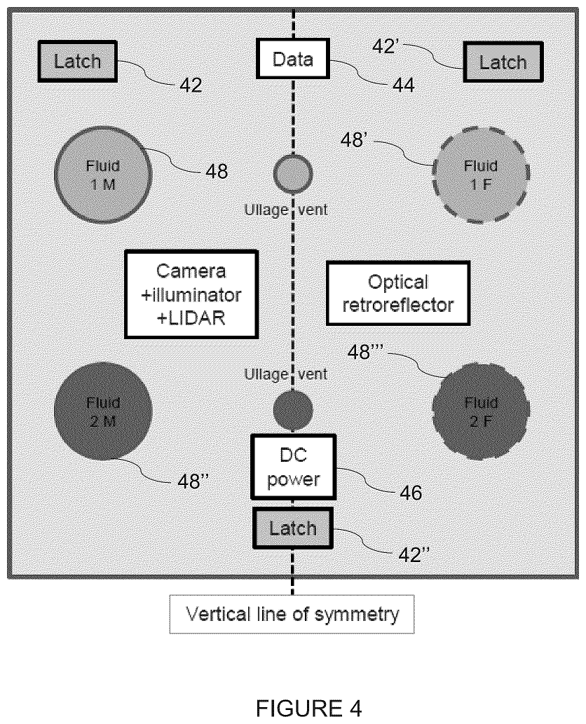

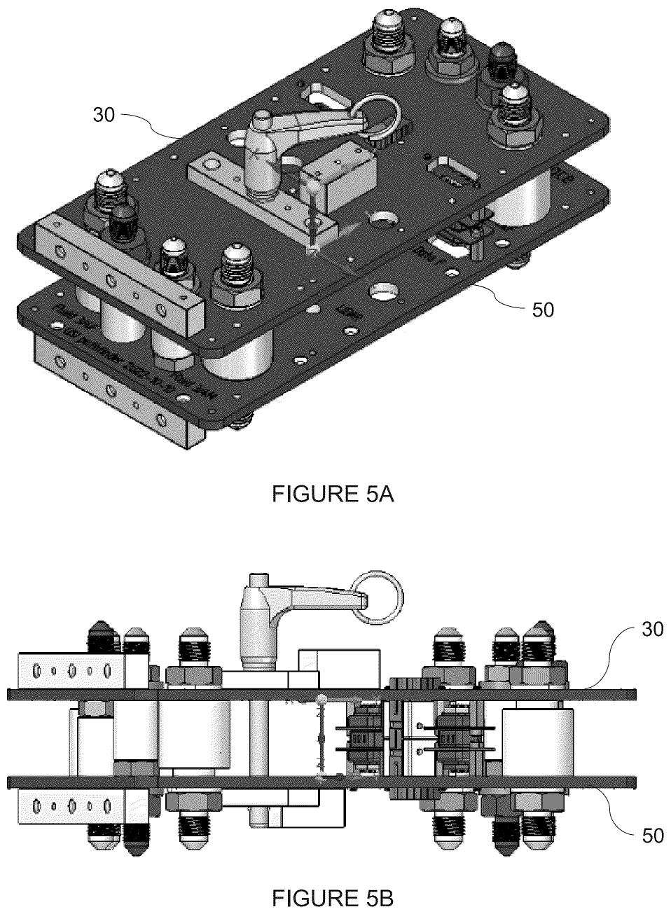

As previously discussed, by being mechanically androgynous, two identical connectors (see FIGS. 5A and 5B) can mate with each other by merely rotating the second connector 50 along the centerline (e.g., 180°) with respect to the first connector 30. Exemplary interfaces can be seen, for example, in FIGS. 3 and 4. As shown in FIG. 4, hermaphroditic connectors (44, 46) may be located on the center line and other connectors (48, 48′, 48″, 48′″) may be located equidistant from the center line. Such an interface may further include at least one key (for proper alignment, not shown) and at least one latch (42, 42′, 42″) for proper alignment and/or securing the connectors once mated together.

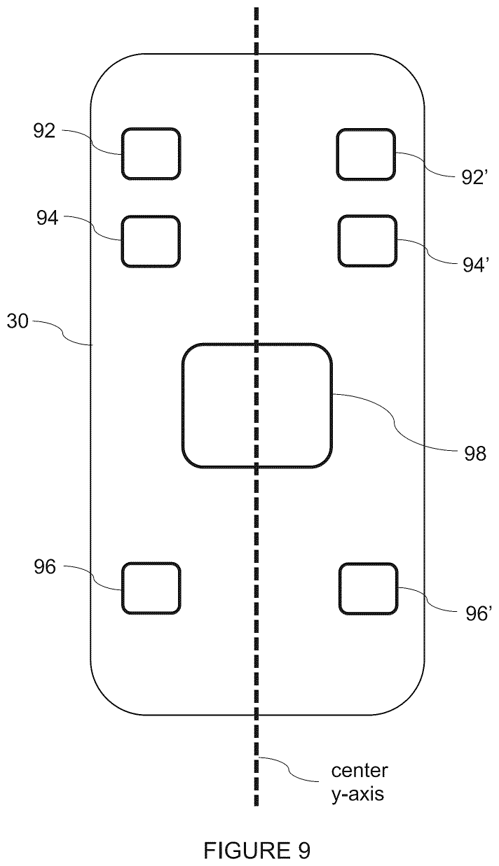

In preferred embodiments of the present invention, the interface further comprises a least one (and preferably a plurality) of sensors. See FIG. 9, showing an exemplary backside of interface 30. It should be appreciated that the number and/or types of sensors may vary based on the application and/or metric to be measured (e.g., different sensors are designed for measuring different metrics for different mediums (liquid, gas, etc.) or energies (e.g., power, data, light, etc.)). The same is true for the location of each sensor (e.g., some may be mounted on the frontside of the interface, the backside of the interface, an attached PCB, a connector or line associated therewith, etc.). The same is true for each connector (e.g., a first connector may be mounted to a frontside of a front panel and a second connector may be mounted to an attached PCB for placement within a corresponding aperture within the front panel).

With respect to the foregoing, different types of sensors are within the spirit and scope of the present invention, including, but not limited to, at least one sensor for measuring pressure, temperature, humidity, bubbles, sound, electromagnetic spectrum, and/or power, or any other metric generally known to those skilled in the art, including metrics for any associated medium (fluid, gas, etc.) or energy (e.g., power, data, light, etc.) passing through any one of the connectors on the interface. Sensors for assisting with mating a first interface with a second interface (e.g., via a robotic arm), for example, a LIDAR sensor or a sensor for measuring visuals (e.g., from a camera), nine degrees of freedom, time-of-flight, and/or time of arrival (ultrasonics) are also within the spirit and scope of the present invention.

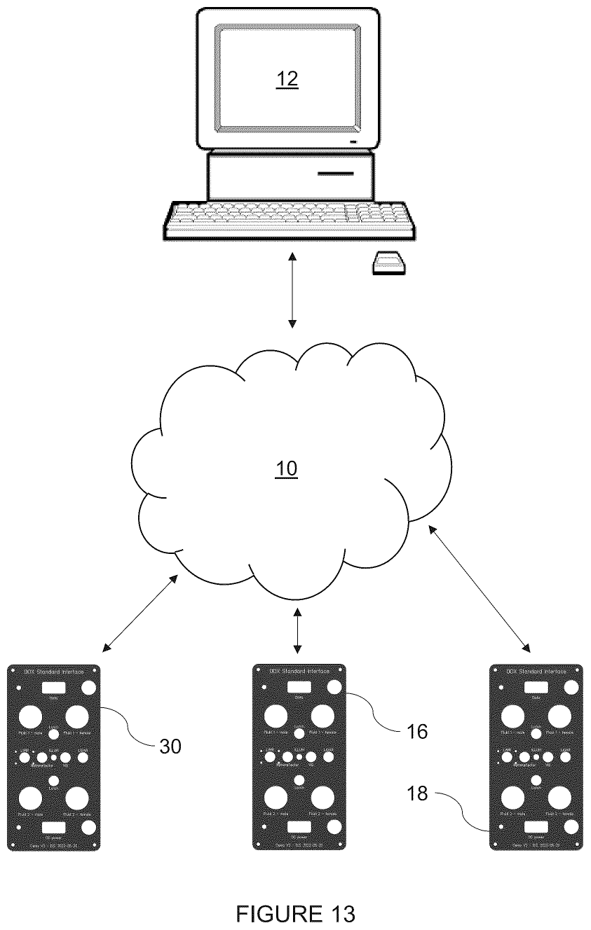

As shown in FIG. 9, the interface (or an associated PCB in other embodiments) may further include at least one processor 98 for receiving sensor data from at least one sensor (92, 92′, 94, 94′, 96, 96′) and to process the same. The processor 98 may further be configured to perform at least one action in response to sensor data. For example, the processor 98 may control at least one feature of the interface (e.g., turn the interface or any connector associated therewith on or off (which may be done electrically or via an associated component, such as a valve for fluid or gas), reduce power, activate LED status lights, etc.) in response to sensor data. The processor 98 may be configured (e.g., via machine readable code, which may be stored on the processor or an associated memory device (not shown)) to do so autonomously or in response to commands or other sensor data received from a remotely located host device (see, e.g., FIG. 13).

The actions taken by the processor 98 may also take into account sensor data received from another interface. For example, sensor data from second interface (mated with the first interface) may be communicated to the first interface (or the processor associated therewith) via at least one wire (e.g., within one of the electrical connectors) or wirelessly (via a transmitter, receiver, or transceiver located on the first and/or second interface) using a known protocol (e.g. RFID, WiFi, Bluetooth, etc.). As shown in FIG. 13, sensor data on remotely located interfaces (16, 18) can also be received, e.g., from a remotely located host device 12 via a wired or wireless local or wide area network 10. Such a system would allow a processor to take actions or control at least one feature on the interface in response to not only local sensor data, but data from at least one other interface (whether connected thereto or otherwise).

In certain embodiments the host device 12 may be used to oversee a plurality of interfaces (or pairs thereof) and to control (or send commands to) individual interfaces to accommodate situations that are occurring on a global scale (e.g., failure or issues with a particular interface, including sensors or connectors attached thereto or mediums or energies passing therethrough). For example, in one embodiment of the present invention involving a network of Distributed Multi-Sensor Multi-Mode quick disconnect interfaces, each individual interface (or pair thereof) can relay data back and forth to other interfaces within the network (e.g., via a host device) so that it may perform a plurality of action: (a) know the status of any measured element in the system, (b) inform the status of any measured element to the rest of the network, (c) provide secure communication from one element to any other element, (d) provide a visual feed across the network, (e) provide alerts, warnings, security actions if measurements in the network deem it necessary, etc.

Certain sensor data may also be useful in mating a first connector with a second connector (e.g., via a robotic arm) (e.g., information from an IR camera, LIDAR, etc.). Mechanical features may also prove useful during the mating process. For example, as shown in FIG. 8A, a first connector 30 may further include at least one nonlinear load limiters (“NLL”) 82 and a second connector 50 may include at least one spacer 80. In one embodiment, as shown in FIG. 8B, bolts 1800 may be used to secure a plurality of springs 1810 on a front panel 1000 via holes 1010. These bolts may pass through holes on bar 1820 such that the bolts can slide through the holes on said bar with the springs being compressed between the bar 1820 and the front panel 1000. An NLL panel 1830 (e.g., in the center of the two bars 1820) may utilize another series of bolts passing through holes near the corner of the NLL panel 1830 and threaded into bars 1820. These bolts may also have springs 1810 surround them. Use of the foregoing may provide a suspension system, aiding in the mating of a first connector 30 with a second connector 50. The NLL may also, or further, to provide a precise load position after impact forces have dissipated. Obviously, other configurations (e.g., a spacer 80 on the first connector 30, at least one NLL on the second connector 50, etc.) are within the spirit and scope of the present invention.

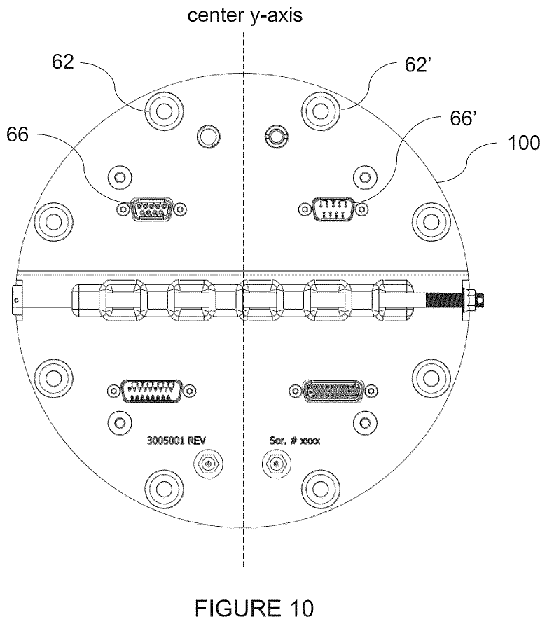

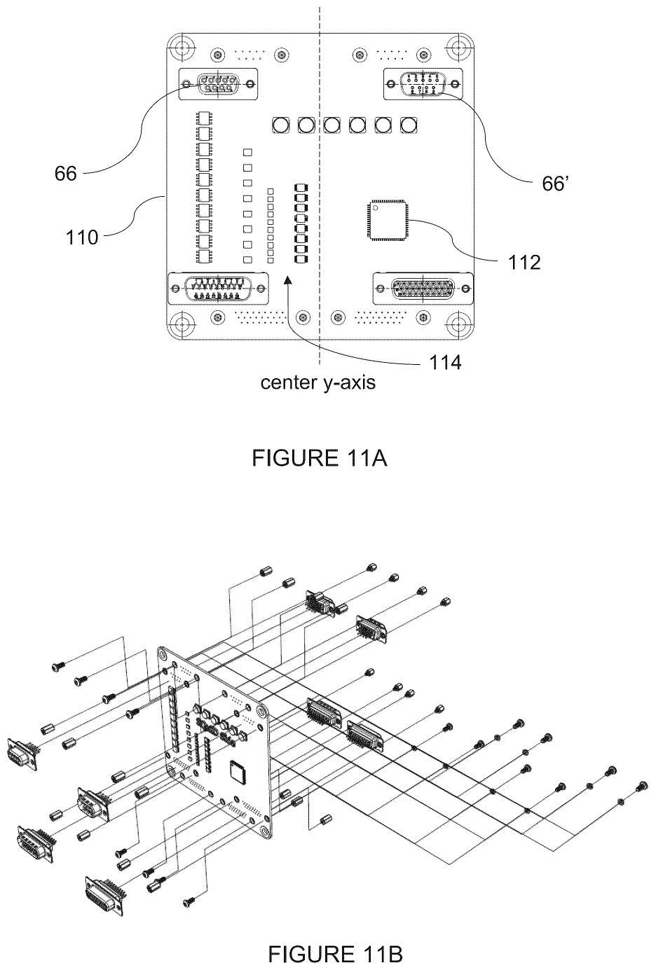

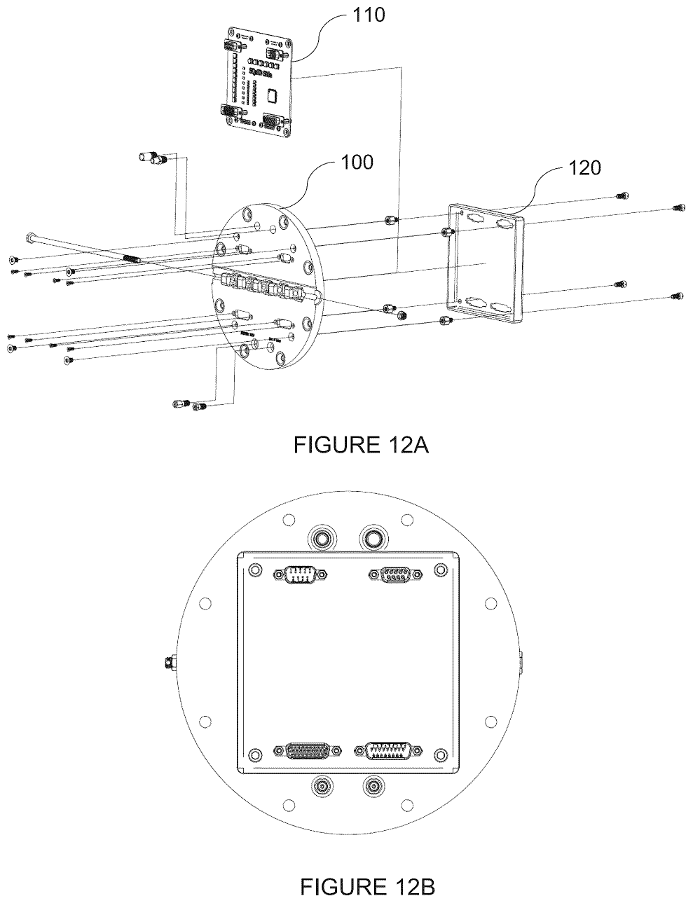

As discussed above, other interfaces, or configurations thereof are within the spirit and scope of the present invention. For example, an alternate interface is illustrated in FIGS. 10-12. As shown in FIG. 10, a front panel 100 may include a plurality of connectors (e.g., fluid/gas connectors (62, 62′), electrical connectors (66, 66′), where certain connectors (e.g., 62, 62′) are mounted on a frontside of the front panel and others (e.g., 66, 66′) are received via corresponding apertures in the front panel. As shown in FIGS. 11A and B, connectors 66, 66′ may be mounted on a corresponding PCB 110, which may further house other electrical and/or mechanical components (e.g., processor 112, sensors 114). As shown in FIGS. 12A and B, the PCB 110 can then be mounted to a backside of the front panel 100, positioned such that connectors 66, 66′ are positioned through corresponding aperture in the front panel 100. A protective cover 114 may further be placed over PCB 110.

Again, it should be appreciated that the present invention is not limited to the interface depicted in FIGS. 10-12, and includes other configurations (e.g., shapes, sizes, etc.). For example, as shown in FIGS. 3 and 9, components (e.g., connectors, sensors, processors, etc.) may be mounted on a single panel. In other embodiments, however, the components (connectors, sensors, processors, etc.) are mounted on different panels, which are then mated together. This can be seen for example in FIGS. 5A and B, and in FIGS. 12A and B. As such, the term “interface” as used herein may comprise a single panel or a plurality of panels connected together, such as a PCB is mounted on a backside of a first panel, as shown in FIGS. 12A and B.

In preferred embodiments of the present invention, the interface, which is mechanically androgynous, can be configured to be either connectively androgynous or non-androgynous. With respect to the latter, gas/fluid connection to the left of center are separate from gas/fluid connections to the right of center. The same is true for electrical connections to the left and right of center. As such, the interface is connectively non-androgynous, and a user would need to ensure that certain mediums and/or energies are not mixed (or crossed) when rotating the second interface with respect to the center axis. While care must be taken when the interface is connectively non-androgynous, a benefit is that it doubles the number of electrical, fluid and/or gas connections as connections to the left of center are separate from those to the right.

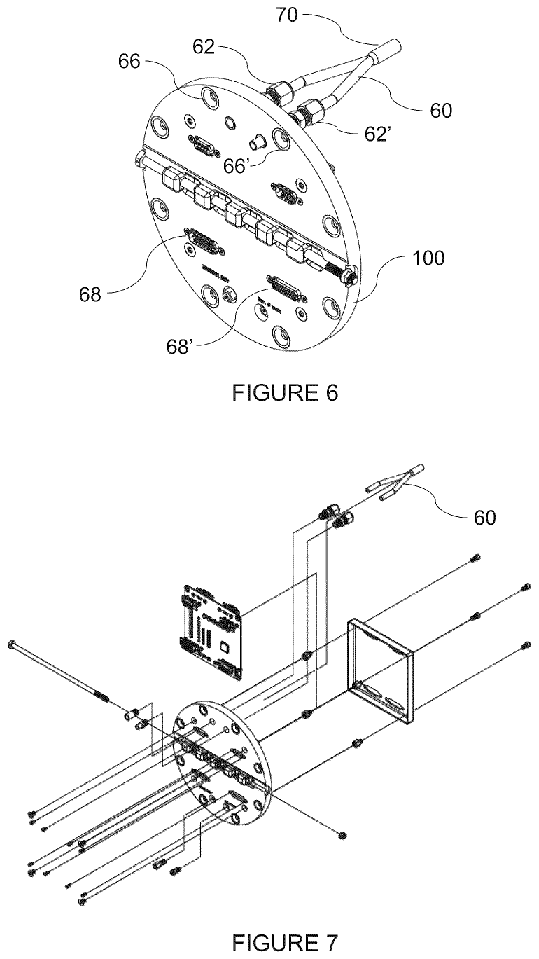

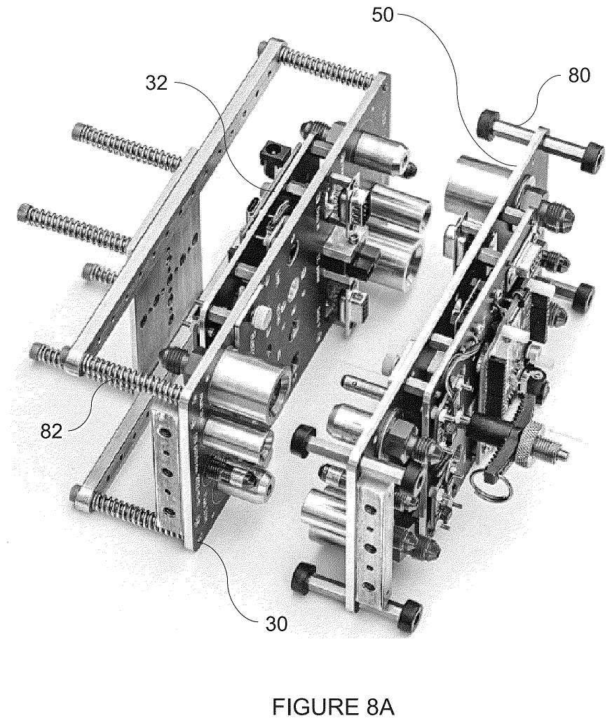

With respect to the prior (i.e., connectively androgynous), gas/fluid connections to the left of center are tied to gas/fluid connections to the right of center. The same is (or can be) true for the electrical connections to the left and right of center (see, e.g., FIG. 6 at 68, 68′). For electrical connections, this can be accomplished via a physical or electrical switch (e.g., controlled via the processor) or at least one physical connection (e.g., a short). For gas and fluid connections, this can be accomplished via a wye (or “Y”) between corresponding male and female connections on the interface. An exemplary wye 60 is shown in FIGS. 6 and 7, where they wye 60 is selectively connected to a first (male) FMI 66 via securing means 62 and a second (female) FMI 66′ via securing means 62′. The wye 60 can be used to connect both lines to a single gas or fluid (or a single output/input 70), thereby making the connection androgynous.

It should be appreciated the reconfigurable nature of the interface (connectively speaking) is not limited that which is shown in FIGS. 6 and 7, and other means (e.g., hose clamps, etc.) for connecting individual connectors together are within the spirit and scope of the present invention. It should also be appreciated that the interface can be partially androgynous and partially non-androgynous (connectively speaking). For example, certain fluid and/or electrical lines may be kept non-androgynous to increase the number of connections in the interface. It should also be appreciated while an interface that is mechanically and connectively androgynous may require additional (e.g., double the number of) connectors, with respect to the prior art, there are benefits associated with doing so. For example, the present invention provides redundancy (e.g., in cases a connector or sensor fails). There are also benefits of having identical sensors (one on the first interface and one on the second (mating) interface) measure the same metric (e.g., different metrics may be indicative of sensor failure, a second reading provides a “reality check” on the first, etc.).

Various exemplary operations of the present invention will now be discussed. In preferred embodiments, the distributed multi-sensor multi-mode quick disconnect system, referred to herein as a “Universal QD Interface,” comprises several elements, which when combined, can allow for the transfer of several different fluids, fuels, cryogens, gases one at a time, in groups all at once. The invention can also transmit power bi-directionally, data bi-directionally, provide structural connection, auto-align during mating of small misalignments, dampen kinetic loads of a hard docking scenario with the assistance of the NLL.

In addition, the interface system may also monitor the state of the overall system as well as its surrounding and component parts. In one embodiment, it is equipped with docking assists including LIDAR, visual and LWIR cameras and a retroreflector. It also has several LEDs and photoreceptors which enable optical communication at short and long distances using specific LEDs. Other LEDs in the system also give visual status of the system such as if data is being transferred, specific gasses are being transferred, electrical data is being transferred. The LEDs also give a visual signal if the locking mechanism is connected, locked, stuck or unlocked.

It is preferably equipped with many sensors to measure conductivity of the fluid/gasses being transferred, whether there are bubbles or contaminants in the system. It has a built-in processor to make smart decisions to prevent mixing fluids/gasses during transfer. The system may be built on a Zero Trust Architecture to prevent accidental or malicious non-desired functions as well as ensure any data or transmission feeds are being accessed.

In a preferred embodiment of the invention, the “Universal QD Interface” is connected to a robotic arm of a self-propelled orbital tug. As the orbital tug approaches another “Universal QD Interface” to dock with, it utilizes the LIDAR to scan the approaching area to figure out where the other “Universal QD Interface” is located, how far it is and its orientation. It also utilizes its visual camera to see the field in front which can scan for LEDs on the second Universal QD Interface to assist in locating, orienting, and learning its status prior to making contact. With the same visual camera, it can utilize the retroreflector on the second Universal QD Interface to confirm its location. The LEDs located on the front panel of the Universal QD Interface can provide optical communication between the Universal QD Interfaces utilizing the photoreceptors. With optical communication, the system can transmit commands such as to communicate via RF signals, or to ask for permission to mate with the second Universal QD Interface.

When the second Universal QD Interface has indicated that it is ready to connect, mate, dock, with the first Universal QD Interface, then the orbital tug will approach closer to a distance of a few meters at which point the orbital tug can pause movement in space and using only its robotic arm mate the first Universal QD Interface with the second Universal QD Interface. Any extra kinetic energy beyond what is needed to physically connect together will be dampened by the NLL. The NLL absorbs kinetic energy by compressing the various springs.

As the two Universal QD Interfaces mate, their components mate as well. For example, the male FMI may enter into the corresponding female FMI of the second Universal QD Interface. Each Universal QD Interface has even sets of FMIs, half being male FMIs and half being female FMIs. Pairs of FMIs are dedicated to fluids and/or pairs to gases respectively. The Fluids can be any assortment of liquids and cryogens including but not limited to, MMH (Monomethyl hydrazine), UDHM (Unsymmetrical dimethylhydrazine), Hydrazine, NTO (Nitrogen tetroxide), MON3, MON25, Deionized water, LOX (Liquid Oxygen), LH2 (Liquid Hydrogen), LCH4 (Liquid Methane), Ethanol, RP1 (Refined Petroleum-1), Water/Propylene Glycol, NH3 (Ammonia), Propane, Isobutane, LN2 (Liquid Nitrogen), Potable water, Cutting fluid, Lubrication oil, other liquids. The gases that can be transferred include but are not limited to HTP (Hight test peroxide), Helium, Nitrogen gas, Krypton gas, Xenon gas, Argon gas, GOX (Gaseous Oxygen), GH2 (Gaseous Hydrogen), GCH4 (Gaseous Methane), N20 (Nitrous Oxide), NOFBX™ (Nitrous Oxide Fuel Blend), CO2 (Carbon dioxide), Shielding gas.

In one embodiment, there are four lines of gases and fluids that can pass through the system in the androgynous configuration. With each pair of Male FMI and Female FMI on each Universal QD Interface making up one line that has two pathways. However, the system can be reconfigured in a non-androgynous way by separating the lines so that there can be up to eight different fluid/gas lines flowing through the system.

Sensors within the Universal QD Interface can listen for bubbles and turbulence with the use of a microphone. It can also utilize an Ultrasonic sensor to hear abnormalities within the lines. Pressure sensors coupled with temperature sensors within the line can provide data (e.g., sound data) which allows it to distinguish different fluids and gasses and ensure that two lines have the same fluid or gas before the valves are open to not cause a cross contamination in the lines.

When the two Universal QD Interfaces mate, the power couplers also connect permitting the flow of electrical power in either direction as controlled by the Universal QD Interface motherboard located behind the front panel. Electrical power can be monitored and adjusted within the system. Loads and peaks can be regulated and shut off as desired.

In one embodiment, on the front panel of the Universal QD Interface, there are two data interfaces, i.e., a male data port and a female data port. The male data port of One Universal QD Interface connects to the female data port of the other Universal QD Interface's female data port, and the female data port of the first Universal QD Interface connects to the male data port of the second data port. This creates two separate lines of data communication across the system. Information can flow in either direction and is also encrypted and based on a Zero Trust Architecture (ZTA). These connections, like the fluid/gas connections, can be configured to be androgynous or non-androgynous.

The interfaces may include several orientation alignment features that assist with the alignment during docking such as mechanical features on the latches, pins, male FMIs, and female FMIs. Additionally, the system may be equipped with cameras for visible light, LWIR (long wave infra-red) as well as LIDAR and a retroreflector to assist in Rendezvous Proximity Operations (RPO) as well as being able to monitor the area the system faces. The invention may also allow for a mechanical structural connection via fail-safe latches that can be locked and unlocked even if one of the two interfaces is malfunctioning as well as structural mechanical fluid interface components.

Once connected, the interface allows for the transfer of fluids, cryogens, fuels, gases, electrical power, and data. In addition to the transferers, the invention also monitors the state of all components and provides some decisions via the embedded software. The system may measure the ambient magnetic field. It may also be capable of knowing orientation via its IMU (Inertial Measurement Unit), ToF (Time of Flight), and 9-DoF (Degrees of Freedom) sensors. It may also measure and provide status on the pressure, temperature, and humidity of the systems.

When many Universal QD Interfaces are used on a space station, it enables a space station to pass the needed fluids and gases, as well as data and system state information from one point of the station to another point of the station. The interfaces are mechanically androgynous in design so as to mate with each other but can also be reconfigured to be non-androgynous (connectively) on the backside to double the number of fluids/gasses that are transferred and/or electrical connections.

In embodiments when many interfaces are utilized together, they form a network which can analyze and provide status of the whole system and parts of the system with a “smart city” capability. The Universal QD interfaces are quick disconnect and can be connected and disconnected multiple times. The interfaces can work as the connection for robot end effectors to utilize different tooling. The Universal QD Interface can be used to connect a robotic arm also equipped with Universal QD Interfaces at both the base of the arm as well as the end effector end of the arm. This Universal QD Interface enabled robotic arm is thus capable of changing out tooling that utilizes a Universal QD Interface as its connection method allowing the robotic arm to perform a variety of functions.

One such function for a Universal QD Interface enabled robotic arm would be to be used as a boom to refuel an approaching space vehicle that is also enabled with a Universal QD interface. The fuels and power can be transmitted via the robotic arm into the space vehicle and refuel its tanks, recharge its batteries as well as provide software updates and data downloads from it.

The Universal QD Interface enabled robotic arm can also perform work by connecting different tools via the Universal QD Interface as an end effector so long as the tooling also has been Universal QD Interface enabled. Such tools, including welders and plasma cutters can be utilized as the Universal QD Interface can transmit the necessary power needed for such tools as well as any gas that may be used.

Such Universal QD Interface enabled robotic arms can also walk across a Universal QD Interface enabled space station by connecting its end effector to the next Universal QD Interface before disconnecting its base Universal QD Interface from the station thus swapping its connection point. The robotic arm would then move its base to the next Universal QD Interface connection on the station and connect before disconnecting its end effector end thus having moved a step across the station. This process can be repeated as necessary to walk from one end of the station to another via the Universal QD Interface interfaces that would be laid out across the station.

The Universal QD Interface enabled robotic arm can also have an antenna mounted to the end effector end of the arm to allow for a movable antenna. In the same fashion, a Solar panel can be attached to the end effector of the robotic arm to make a Solar Array Drive (SAD) that is connected at the base mount. Such robotic arms do not need to be limited to a space station, but can also be utilized in a lot of locations such as on space tugs, satellites, orbiting vehicles as well as many Earth-bound applications such as on a vehicle on the road so that it can refuel without a passenger leaving the vehicle, which would be beneficial in a dangerous environment such as a war zone or bad weather.

In fact, in embodiments, the robot itself may be assembled from components that are modularity interconnected using the present invention. For example, robot joints may connect to the arm segments using the present invention in building block fashion.

In one embodiment, a space station can be equipped with hundreds of these interfaces to allow not just the connection and transference of data/fluids/gases/power but also to be the connector for habitational modules, research modules, attachment points for Solar Array Drives, Payloads, Robotic arms as well as to allow visiting spacecraft and satellites to be refueled, recharged, transfer data for system upgrades and diagnostics.

It may allow for hard docking via robotic means in space or in situations when a human-in-the-loop is not available. It may also be able to connect by human hands when a human-in-the-loop is available.

In alternate embodiments, the invention can also be used on ground applications such as in chemical plants to transfer different gases and liquids throughout a plant in addition to monitoring what is occurring within the lines transferring said elements. It can transfer power to different sectors in a smart grid fashion.

By way of example, the invention can also be used as a quick disconnect end effector for robotic arms in a factory where changing tools are necessary and can assist in its quick disconnect/connect function by using the camera feed to see where tooling on a conveyor belt is at and its orientation for automatic tool changing, in underwater applications such as on an oil rig, to transfer oil through the system while monitoring the state of the oil being transferred, or on vehicles, planes, or submarines to automate refueling, and topping off on fluids while doing a diagnostic of the computer system if so equipped.

Having thus described several embodiments of a distributed multi-sensor multi-mode quick disconnect interface, it should be apparent to those skilled in the art that certain advantages have been achieved. It should also be appreciated that various modifications, adaptations, and alternative embodiments thereof may be made within the scope and spirit of the present invention. For example, mated interfaces may have certain differences and still be mechanically androgenous. For example, a first interface may have a sensor that is not present on the second interface, only one interface may include an NLL (see FIGS. 8A and B), etc. In other words, the interface is mechanically androgynous (for purposes of the present invention) if it can mate with an identical interface. The invention is solely defined by the following claims.

What is claimed is:

1. A universal quick disconnect interface comprising a first interface and a second interface that are configured to mate with one another, wherein said first interface is identical to said second interface and comprises:
at least one male connector on a front side of said first interface, said male connector being located toward a first edge of said first interface a predetermined distance from a center y-axis of said first interface;
at least one female connector on said front side of said first interface, said female connector being located toward a second edge of said first interface said predetermined distance from said center y-axis of said first interface;
a first sensor for measuring at least one metric associated with that which passes through said male connector;
a second sensor for measuring at least one metric associated with that which passes through said female connector; and
a processor for receiving said metrics from said first and second sensors and for controlling at least one feature on said first interface in response thereto.

2. The universal quick disconnect interface of claim 1, wherein said processor is further configured to receive additional metrics from sensors on said second interface and to compare the same to metrics received from said first and second sensors on said first interface.

3. The universal quick disconnect interface of claim 2, wherein said processor is further configured to receive said additional metrics from said sensors on said second interface from a second processor on said second interface via at least one electrical connection between said first and second interfaces.

4. The universal quick disconnect interface of claim 1, further comprising a wye between said male and female connectors, making said connections between said first and second interface androgynous.

5. The universal quick disconnect interface of claim 1, wherein said first and second connectors are compression fittings for the transfer of liquid or gas from said first interface to said second interface.

6. The universal quick disconnect interface of claim 1, wherein said first and second connectors are electrical connectors for the transfer of power, commands, or data from said first interface to said second interface.

7. The universal quick disconnect interface of claim 1, wherein said first interface further comprises at least one camera, said at least one camera being selected from an infra-red (IR) camera and a light detecting and range (LIDAR) camera.

8. The universal quick disconnect interface of claim 1, wherein said first and second sensors are identical for sensing the same metric with respect to that which passes through said male and female connectors.

9. The universal quick disconnect interface of claim 8, wherein said same metric is selected from a list of metrics comprising voltage, current, power, pressure, temperature, humidity, sound, electromagnetics, bubbles, and turbulence.

10. The universal quick disconnect interface of claim 4, wherein said wye is removable attached to said first interface, wherein removing said wye results in a doubling of the number of connections between said first and second interface.

11. The universal quick disconnect interface of claim 1, wherein said processor is further configured to communicate with a remote host via a wide area network, wherein said control of said at least one feature is further based on said communications.

12. The universal quick disconnect interface of claim 11, wherein said communications received from said remote host comprise information on a second, remotely located universal quick disconnect interface.

13. The universal quick disconnect interface of claim 1, further comprising a second male connector and a second female connector on said front side of said first interface, wherein said second male and female connectors are on opposite sides of and equidistant from said center y-axis of said first interface.

14. The universal quick disconnect interface of claim 13, further comprising a second removable wye between said second male and female connectors.

15. A universal interface comprising a first portion and a second portion that are configured to mate with each other, wherein said first and second portions are androgynous and said first portion comprises:
a plurality of connectors comprising at least one male connector and at least one female connector, wherein a first one of said plurality of connectors is a predetermined distance from a center of said first portion and a second one of said plurality of connectors is opposite said first one of said plurality of connectors said predetermined distance from said center of said first portion such that said first one of said plurality of connectors on said first portion mates with a second one of a plurality of connectors on said second portion and said second one of said plurality of connectors on said first portion mates with a first one of said plurality of connectors on said second portion;
a plurality of sensors comprising a first sensor for measuring at least one metric associated a medium that flows through said first one of said plurality of connectors and a second sensor for measuring at least one metric associated with a medium that flows through said second one of said plurality of connectors; and
a processor for receiving said metrics from said plurality of sensors and making at least one electrical adjustment in response thereto.

16. The universal interface of claim 15, further comprising a wye between said first and second connectors.

17. The universal interface of claim 15, further comprising additional pairs of connectors, each pair comprising one male and one female connector disposed the same distance but opposite from said center of said first portion.

18. The universal interface of claim 15, wherein said processor is configured to receive said at least one metric associated with said medium that flows through said first one of said plurality of connectors from both said first sensor and from a sensor on said second portion.

19. The universal interface of claim 18, wherein said processor is further configured to communicate with a second processor on said second portion via an electrical connection therebetween, said communication including at least said at least one metric from said sensor on said second portion.

20. The universal interface of claim 15, wherein said processor is further configured to communicate with a remote host to receive metrics associated with a second universal interface.
